(19) United States
(12) Patent Application Publication
(10) Pub. No.: US 2026/0327986 A1
(43) Pub. Date: Oct. 22, 2026

(54) Module having draining properties, and roof system incorporating such modules

(71) Applicant: SOPREMA, STRASBOURG (FR)

(72) Inventors: Pierre-Etienne BINDSCHEDLER, STRASBOURG (FR); Renaud UHL, OTTERSWILL (FR); Lionel SINDT, MUHLBACH SUR MUNSTER (FR)

(21) Appl. No.: 19/109,798

(22) PCT Filed: Sep. 7, 2023
(86) PCT No.: PCT/EP2023/074611

§ 371 Date: Mar. 7, 2025

(30) Foreign Application Priority Data
Sep. 12, 2022 (FR) FR2209111

(51) Int. Cl. E04D 11/00

(52) U.S. Cl. CPC E04D 11/002

(57) ABSTRACT

A module (1) having a body (2) in the form of a grid plate having a cellular structure, and a flank (3) which is made of non-woven material, is attached to one of the faces of the plate (2), corresponds to the upper face of the plate and totally covers the plate, preferably overshooting at least two lateral sides (4, 4′, 4″′) of the plate (2). The non-woven material which forms the flank (3) has capillary action properties and in that the flank (3) has at least one lateral portion (5) which extends beyond the edge and along the flank of at least one of the lateral sides (4, 4′, 4″, 4′″) of the plate (2), at least as far as the plane of the lower face (2′″) of the plate. The at least one portion (5) of non-woven material constitutes a wick for raising liquid by capillary action towards the portion (3′) of the sheet (3) resting on the upper face of the plate (2).

The present invention relates to the field of construction systems and equipment, notably for flat roof structures, which are traffic-resistant or otherwise, for example green roofs, and concerns a module with a cellular structure with draining properties and a roof system incorporating such modules.

Modules in the form of panels or plates with an ultralight cellular structure (ULCS) are already widely known for applications in buildings, landscaping, traffic-resistant surfaces and the like.

Indeed, these structured panels or plates, with cells having a polyhedral shape with a polygonal, and preferably hexagonal (honeycomb), section are used to form intermediate layers to achieve large empty volumes, high compressive strength (in a direction perpendicular to the opposing faces of the plate, i.e. in the direction of the axes of the cells), and lightweightness.

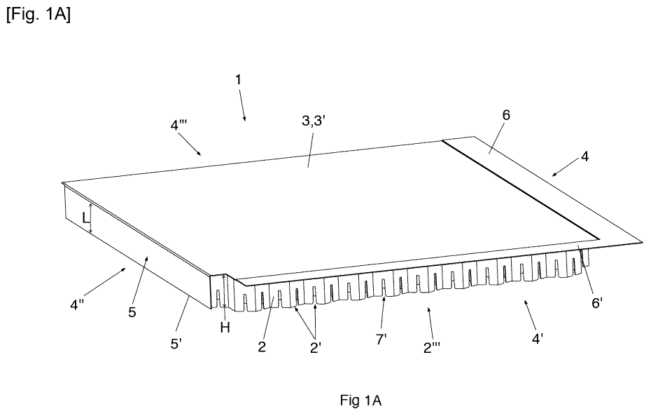

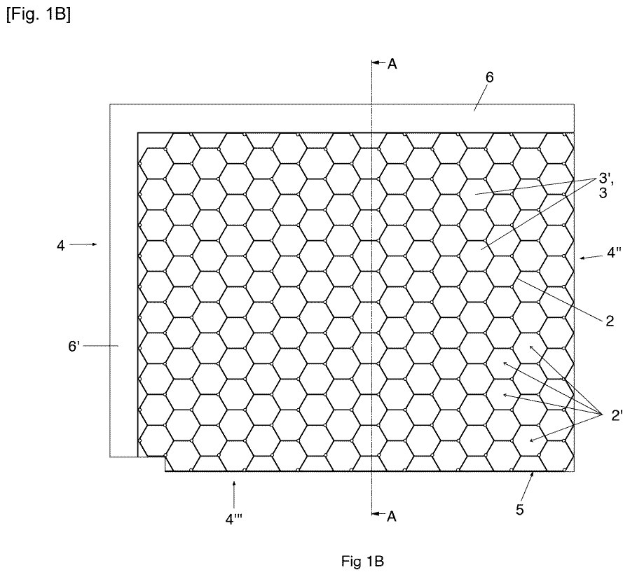

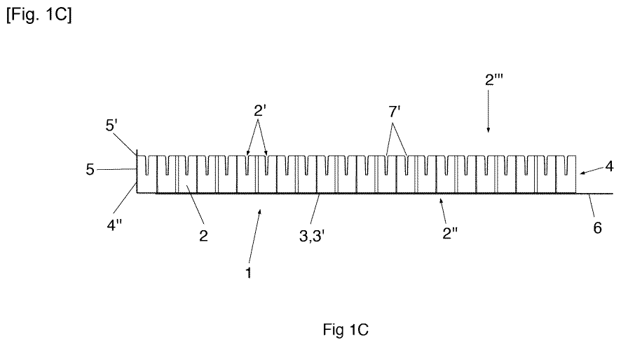

The applicant's “RETENTIO®” system (registered trademark), is an example of application, shown schematically in cross-section in FIG. 1 of document FR 3080635 in the context of a flat roof with temporary rainwater retention, said system comprising modules having an ultralight cellular structure (ULCS), known as RETENTIO® modules, which rest on a horizontal drainage layer formed of a geocomposite made of a non-woven geotextile associated with an extruded grid, known as Drain RETENTIO®. A geotextile (for example the applicant's SOPRAFILTRE geotextile) may be attached to the upper face of the modules, when the system is covered (protective surface layer, which may or may not be pedestrian-or vehicle-resistant, greened or planted).

In this case, the cellular product is mainly used to create an empty volume between a watertight layer and a covering, load-bearing or otherwise (greening, cement screed, paving stones or slabs, etc.) for the temporary storage of rainwater, in roofs or underground storage.

In a variant embodiment, described notably in document EP 3564459, the walls of the cells of the modules include openings in the form of slots constituting cutouts opening onto the lower face of the respective module. These walls provided with slots form a chicane structure allowing the flow of liquids on the underside of the modules to be regulated, and can be used if necessary instead of a specific drainage layer here, notably if the cells include a liquid retention/diffusion material.

Where there is a greened or planted top layer, a regular supply of water may be desirable or even essential to ensure the plants and vegetation there bloom, or at least survive.

Thus, when implementing modules in the form of panels or plates with an ultralight cellular structure, in particular as explained above, the problem addressed by the invention consists of proposing a simple solution to improve at least the hydration of a greened or planted top covering layer, if possible without using any additional elements and without significantly altering the manufacture or on-site installation of such modules.

For this purpose, the invention relates to a module comprising a body in the form of a grid plate with a cellular structure and a substantially rectangular or square contour, the cells of which have a polyhedral shape with a polygonal cross-section, and a sheet or piece of non-woven material, attached to one of the faces of the plate, corresponding to the upper face of the latter, and covering the latter in full, preferably protruding over at least two lateral sides of said plate,

characterized in that the non-woven material forming the sheet or piece has water capillary properties and in that said sheet or piece has at least one side portion (5) extending beyond the edge and along the flank of at least one of said lateral sides of the plate at least as far as the plane of the lower face of the latter, said at least one portion of non-woven material forming a wick for lifting the liquid by capillary action towards the part of the sheet resting on the upper face of said plate.

The invention can be better understood from the description of preferred embodiments provided below as non-limiting examples and explained with reference to the attached schematic drawings, in which:

FIG. 1A is a perspective top view of a module according to an embodiment of the invention;

FIG. 1B is a bottom view of the module in FIG. 1A;

FIG. 1C is an elevation view in cross-section along A-A of the module in FIG. 1B;

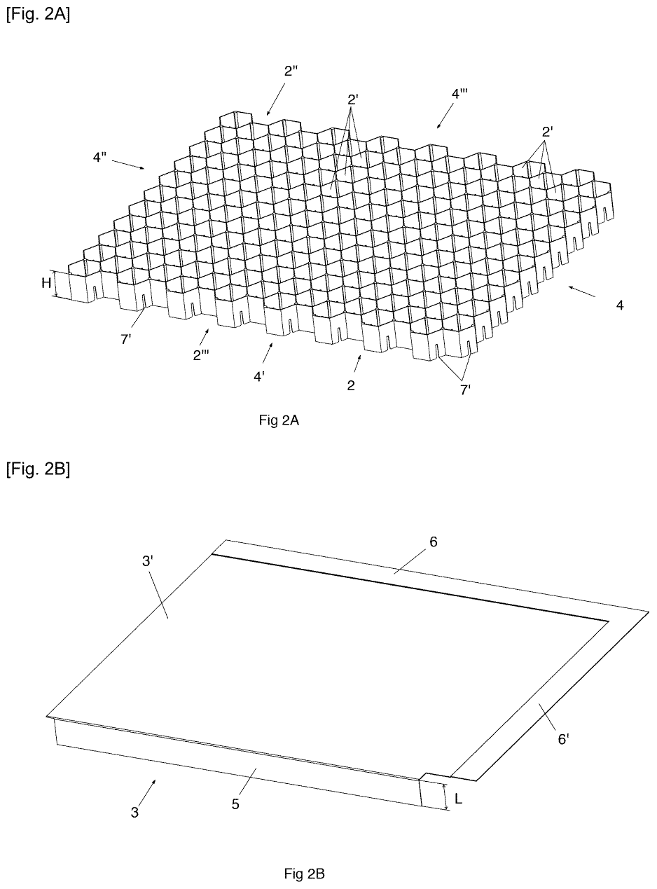

FIG. 2A and

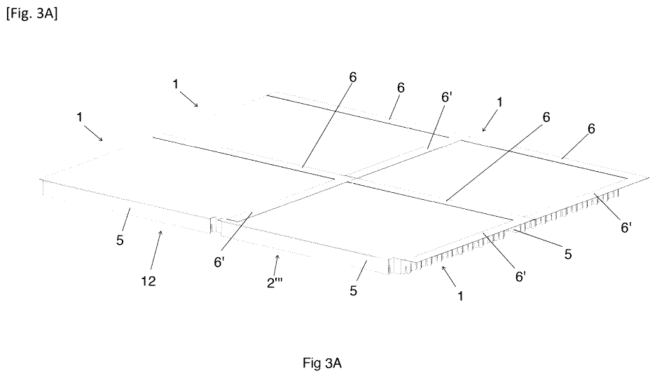

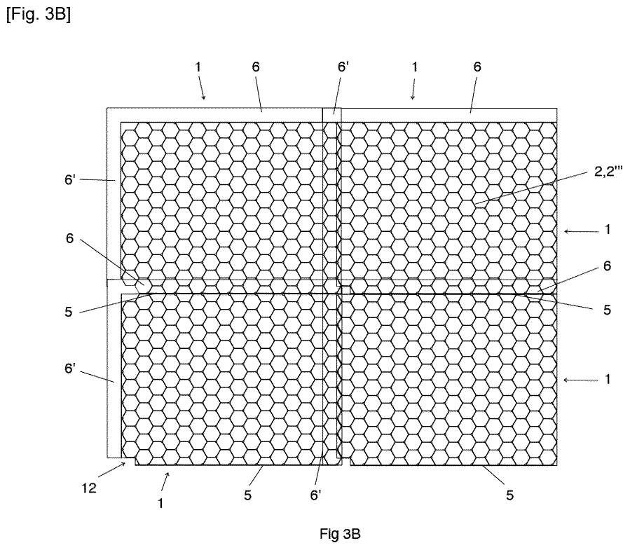

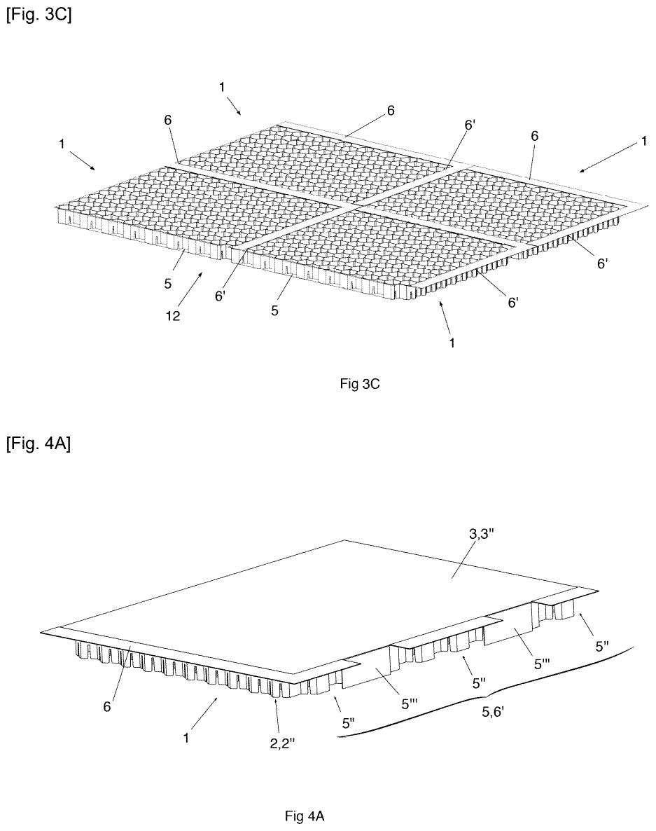

FIG. 2B are perspective views of the two constituent components of the module in FIG. 1, specifically the plate with a cellular structure (FIG. 3A) and the sheet of non-woven material (FIG. 3B);

FIG. 3A and

FIG. 3B are perspective and bottom views respectively of an assembly of four modules according to FIG. 1, forming a part of a drainage and water retention layer;

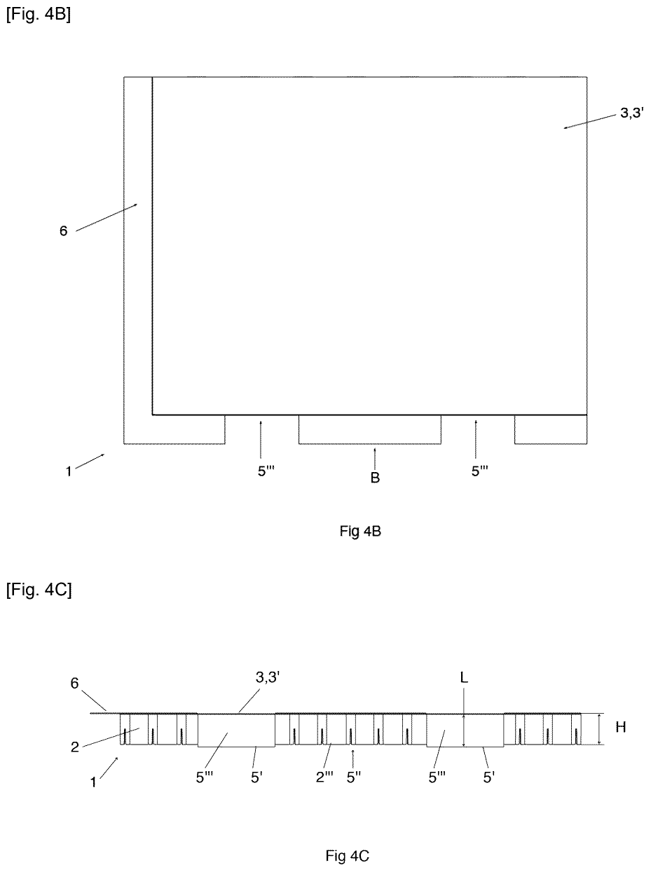

FIG. 3C is a view identical to FIG. 4A, showing the overlapping by the projecting side portions in the form of strips, but showing the abutting modules by transparency through the sheets of non-woven material;

FIG. 4A is a perspective top view, on a different scale, of a module according to a second embodiment of the invention;

FIG. 4B is a top view of the module in FIG. 4A;

FIG. 4C is a side elevation view in the direction B of the module in FIG. 1B;

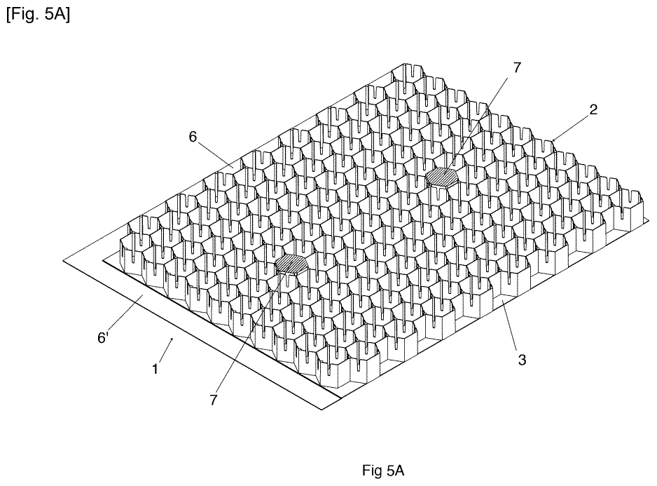

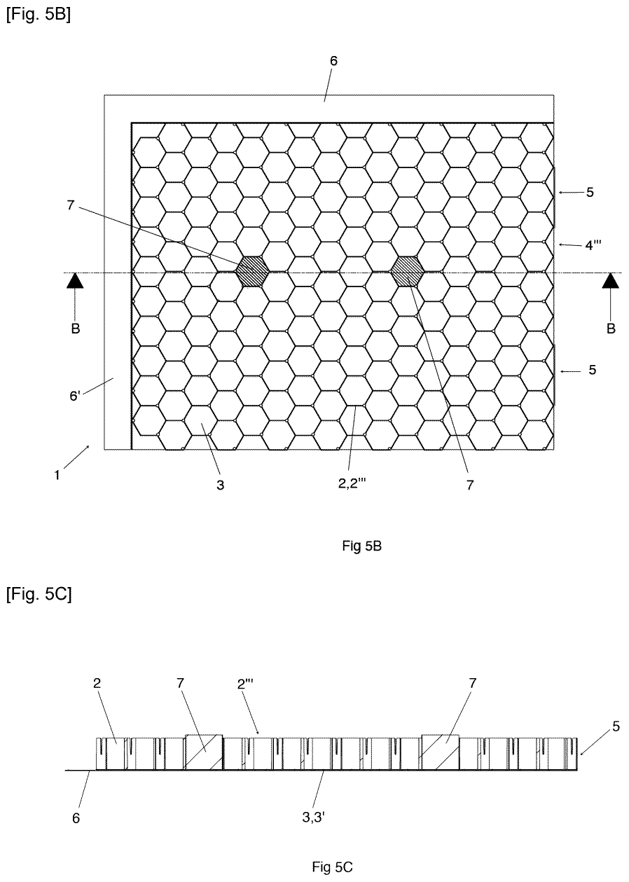

FIG. 5A is a perspective bottom view, on a different scale, of a module according to a third embodiment of the invention;

FIG. 5B is a bottom view of the module in FIG. 5A;

FIG. 5C is an elevation view in cross-section along B-B of the module in FIG. 5B;

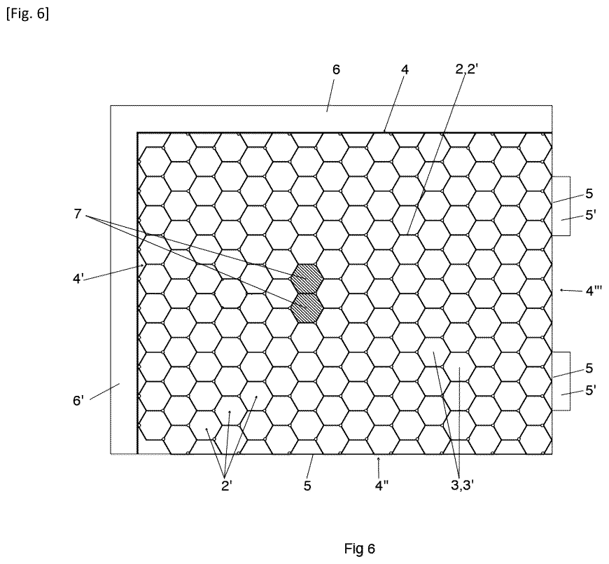

FIG. 6 is a bottom view of a module according to a fourth embodiment of the invention, combining features of the three aforementioned embodiments in FIGS. 1 to 5;

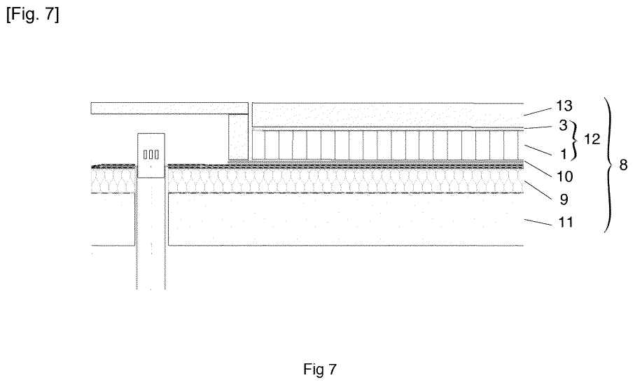

FIG. 7 is a schematic cross-section view of an embodiment of a greened flat roof according to the invention.

FIGS. 1 and 3 to 6 illustrate a module (1) comprising a body (2) in the form of a grid plate with a cellular structure and a substantially rectangular or square contour, the cells (2′) of which have a polyhedral shape with a polygonal cross-section, and a sheet or piece (3) of non-woven material, attached to one of the faces of the plate (2), corresponding to the upper face (2″) of the latter. This sheet or piece (3) completely and continuously covers the entire upper face (2″) of the plate (2), preferably protruding over at least two lateral sides (4, 4′, 4′″) of said plate (2).

According to the invention, this module (1) is characterized in that the non-woven material forming the sheet or piece (3) has water capillary properties and in that said sheet or piece (3) has at least one side portion (5) extending beyond the edge and along the flank of at least one of said lateral sides (4, 4′, 4″, 4″′) of the plate (2) at least as far as the plane of the lower face (2″′) of the latter, said at least one portion (5) of non-woven material forming a wick for lifting the liquid by capillary action towards the part (3′) of the sheet (3) resting on the upper face (2″) of said plate (2).

By virtue of these arrangements, and notably the presence of the sheet or piece (3) with the aforementioned features, the invention provides a simple and economical solution for using the water present under the hollow perforated plate (2) (for example, a pool or layer of rainwater) to wet a green layer (13), or a thickness of planted substrate, on top of the module (1). Indeed, the nature of the sheet or piece (3) and the arrangement thereof on the plate, and the presence of at least one wick-forming portion enable said sheet or piece to lift the water from the lower face (2″′) by vertical capillary action and diffuse it horizontally into the part (3′) of the sheet (3) resting on the plate (2) and bearing the green layer, thereby wetting the latter from below. It will be noted that the inventive solution requires only the provision of at least one additional strip of material of the sheet (3). Moreover, it does not alter the manufacture of the modules (1) or the on-site installation thereof.

Of course, a single wick or several wicks may be provided, on one lateral side or on two or more lateral sides of the plate, and the extension along the respective lateral side may be variable.

According to a first advantageous feature, the or at least some of the wick-forming portions (5) have an extension length (L) at least equal to, and preferably greater than, the height (H) of the flank of the plate (2). “Extension length” here means the length of the wick which extends beyond the upper edge of the respective side (dimension of extension beyond the upper face of the plate).

This arrangement guarantees contact of the or each wick (5) with the bearing surface of the plate and therefore with the underlying water, regardless of the depth thereof, or provides a surface contact zone between the wick and the water, or even enables an end strip (5′) of the respective wick (5) to cover a larger area on the underside. FIGS. 4C and 6 illustrate examples of modules (1) with wick forming portions (5) in which L>H, and which have such a strip (5′) at one end, said strip being (before the module is installed) located in the plane of the respective wick (FIG. 4C), or folded and therefore located in a plane perpendicular to the plane of the wick (FIG. 6).

As a simple and effective alternative embodiment of the invention, illustrated by way of example in FIG. 1, the module (1) may comprise a single wick-forming portion (5) located on a single lateral side (4″) of the plate (2), said portion (5) extending in one piece along the entire length of said side (4′″) or along only a part thereof. If the plate (2) is rectangular, the portion (5) may extend along a side constituting a length of said rectangle or alternatively along a side forming a width, depending on the water requirement, the location thereof on the underside, economic considerations, and on-site installation conditions.

In an alternative structural variant, illustrated for example in FIGS. 4, 5B and 6, the module (1) may comprise at least two distinct wick-forming portions (5) located on one and the same lateral side (4″) of the plate (2) or on at least two different lateral sides (4″, 4″′), said portions (5) extending, depending on the case, over the entire length of the respective side (4″, 4″′) or over only a part thereof.

As shown in FIG. 6, a module (1) combining the features of the two aforementioned variants may also be provided, i.e. including, on a first side (4″), a single wick-forming portion (5) extending in one piece over the entire length of said side and, on a second side (4″′), at least two distinct and separate wick-forming portions (5), each extending only over a part of this side. In this case, the water supply by capillary action comes from two different sides and the concentric diffusion thereof from several points guarantees redundant wetting of the entire part (3′) of the sheet bearing the green layer.

FIGS. 1 and 3 to 6, as well as the details given above, enable a person skilled in the art to understand the plurality of possible structural variants, and show the possibilities in terms of flexibility and adaptability of the module (1) to different situations and demands.

As can be seen by way of example in FIGS. 1 and 4 to 6, the or each wick-forming portion (5) is advantageously folded back against the flank or edge of the respective side (4″, 4″′), and preferably secured to at least some of the walls of the cells (2′) forming this flank, a free end strip (5′) of this portion (5) preferably protruding from the lower edge of said flank (FIGS. 4 and 6).

Positioning one or more wicks in advance avoids complications at the time of on-site installation, and linear or surface contact can be guaranteed on the underside, depending on the length (L). Securing can be carried out in different ways: thermally, chemically (glueing), acoustically (vibration welding), or mechanically (stapling).

As illustrated by way of example in FIG. 4 for example, the or each side portion (5) may include cutouts (5″) forming openings enabling direct contact or partial interlocking of the respective lateral flank of said module (1) with the lateral flank of another abutting module (1) and/or defining several elementary wicks (5″′) spaced apart and arranged along the respective side (4″, 4″′).

These elementary wicks (5″′) preferably extend along the walls of the peripheral cells defining the respective lateral side of the plate, and are for example glued against these walls.

Such a structural variant avoids any interference during the abutting assembly of the plates of the modules and allows the abutting plates to be interlocked at the contacting sides thereof (level with the cutouts). Furthermore, a discontinuous wick or multiple spaced-apart wicks do not disturb the flow of water on the underside, notably excess rainwater to be evacuated.

As shown in FIGS. 1 to 6, the sheet or piece (3) of non-woven material advantageously includes two other side portions (6, 6′) in the form of continuous strips extending beyond the edges and along two contiguous lateral sides (4 and 4′) of the plate (2), thereby forming an L-shaped protruding portion, the or each wick-forming portion (5) being associated with one of the other two sides (4″′, 4″″) of this plate (2)—FIGS. 1 to 3 , 5 and 6—or being cut out from one of these two side portions (6, 6′)—FIG. 4.

Once the modules (1) have been installed in abutment with one another, the two side portions (6 and 6′) of the sheet (3) of a given module laterally overlap the sheets (3) of the other two adjacent modules (1) on the respective sides and overlap these sheets (3) along strip-shaped edge zones, some of which are extended by wicks (5, 5″′). This provides a continuous layer with the non-woven material of the sheets of the different modules, this continuity being not only physical (retaining barrier for the soil or substrate layer for example) but also hydraulic or capillary, and enables the water sucked up by the wick or wicks (5, 5″′) of a module to be diffused to the adjacent abutting modules.

Such bridging between modules also ensures redundant horizontal diffusion of the water between modules, enabling water resources to be shared and securing the supply on account of the multiplicity of draw-off points.

According to another additional feature of the invention, illustrated notably in FIGS. 5 and 6, the sheet or piece (3) of non-woven material of a module (1) may include, on the part (3′) thereof resting on the upper face (2″) of the plate (2), one or more portions or formations (7) of attached, cut and/or deformed material extending inside a cell or cells (2′) located opposite, preferably from the sheet (3) at least as far as the plane of the lower face (2″′) of said plate (2), and each constituting a wick for lifting liquid by capillary action.

This provides one or more additional wicks (5, 7) located inside the perimeter of the upper face (2″) of the plate (2), providing a supply of water directly into the surface of the respective module (1), in addition to the supply from the wick or wicks (5) located at the periphery (see FIGS. 5B and 6). Such an embodiment may be beneficial for large modules. Moreover, and in combination with the various embodiments of the peripheral wicks (5, 5′″) mentioned above, this arrangement even further multiplies the options in terms of adaptive variants of the module (1) according to the invention.

These additional wicks (7) extending through the plate (2) may be made of the same material as the sheet (3), and may be in the form of strips or material for filling the respective cell (2′), and are in contact with and optionally secured to the sheet (3). They may also be made of a different material, be injected into the respective cell and have capillary properties.

In relation to an optimized application of the invention, in particular an efficient ratio of resources to results, the number, dimensions and arrangement of the wick-forming portion or portions (5), and optionally of the wick-forming formation or formations (7), are advantageously determined in consideration of the shape and size of the plate (2), as well as the conditions for implementing said module (8). For this purpose, the installer may be provided with a tool such as a nomogram or a digital simulation tool based on the results of tests and field experience.

Preferably, and in relation to a simple, economical and robust method of manufacture, the connection between the body (2) in the form of a grid plate with a cellular structure and the sheet or piece (3) of non-woven geotextile material made of synthetic fibers is a material connection, said plate (2) being overmolded on said sheet or piece (3), the melting temperature of the material forming the plate (2) being advantageously lower than the softening temperature of the material of the fibers of the non-woven material forming the sheet or piece (3).

“Capillary properties” here means the ability of the non-woven material of the sheet or piece (3) to convey water along each wick (5, 5′″) against gravity from the lower face (2′″) of the plate (2) to the upper face (2″) thereof. Such a material normally also has water diffusion properties in a horizontal or slightly inclined plane, in this case the plane of the portion (3′) of the sheet (3), the two properties being linked. A person skilled in the art can use their knowledge in the field of materials to choose the non-woven materials suitable for implementation within the scope of the invention, notably having sufficient capillary properties to ensure the water is lifted over the height (H), typically from a few centimeters to one or two tens of centimeters.

By way of non-limiting example, a suitable type of non-woven material advantageously provides a water supply of at least 300 ml/m², advantageously of approximately at least 450 ml/m² and preferably of the order of 600 ml/m². Furthermore, the rate of diffusion of the water into the respective material will be such that diffusion over 5 cm will advantageously take less than 3 minutes, preferably less than 1.5 minutes, and diffusion over 10 cm will advantageously take less than 10 minutes, preferably less than 6 minutes.

According to a practical variant embodiment of the invention, the sheet or piece (3) may consist of a non-woven material of synthetic fibers with water capillary and water diffusion properties, preferably a geotextile, for example composed of a mixture of polyamide and polyester microfibers bonded together. A typical but non-limiting example of such a geotextile is EVOLON® (registered trademark), notably type 150 PK TL, from Freudenberg.

The plate (2) may be made of polypropylene or ABS, optionally at least partially recycled. When the geotextile is overmolded by the molten material intended to form the plate, said material does not penetrate the geotextile, but remains on the surface and acts as a surface contact adhesive. Thus, the capillary properties of the geotextile are not degraded.

As shown in FIGS. 1 and 2, at least some of the walls of the cells (2′), common to two cells or otherwise, include slot-shaped cutouts (7′) extending from the lower face (2′″) of the plate (2) to at least halfway up the respective wall.

An embodiment according to this arrangement is described notably in the document FR 3080635 cited above. This obviates the need to use Drain RETENTIO when using modules (1) in combination with the applicant's RETENTIO® system.

The invention also relates, as shown by way of example in FIG. 7, to a green or planted flat roof device (8) comprising a flat support (9) which is watertight or covered with a watertight membrane (10), optionally with an interposed insulating layer (11).

According to the invention, this device (8) is characterized in that it also includes a layer (12) formed by the abutting assembly of modules (1) with a cellular structure in the form of plates as described above, with partial overlapping of the sheets or pieces (3) of non-woven material of the different modules (1) by means of projecting side portions (6, 6′), this continuous layer (12) forming a temporary or non-temporary water retention and controlled-drainage layer, and being covered with a green or planted protective layer (13).

To guarantee a water supply that minimizes or even eliminates watering phases, the support (9) and/or the watertight membrane (10) may be designed in such a way as to promote the formation and preservation of a layer or pools of water under the layer (12) formed by abutting modules (1). Alternatively or additionally, the inlet opening of the safety overflow or overflows may also be raised to ensure sufficient water retention.

Of course, the invention is not limited to the embodiments described and shown in the attached drawings. Modifications may be made to the invention, notably in terms of the constitution of the different elements or by substitution for technical equivalents, without thereby departing from the scope of protection of the invention.

1. A module comprising a body in the form of a grid plate with a cellular structure and a substantially rectangular or square contour, the cells of which have a polyhedral shape with a polygonal cross-section, and a sheet or piece of non-woven material, attached to one of the faces of the plate, corresponding to the upper face of the latter, and covering the latter in full,
wherein the non-woven material forming the sheet or piece has water capillary properties and in that said sheet or piece has at least one side portion extending beyond the edge and along the flank of at least one of said lateral sides of the plate at least as far as the plane of the lower face of the latter, said at least one portion of non-woven material forming a wick for lifting the liquid by capillary action towards the part of the sheet resting on the upper face of said plate.

2. The module as claimed in claim 1, wherein the or at least some of the wick-forming portions have an extension length at least equal to the height of the flank of the plate.

3. The module as claimed in claim 1, wherein the module comprises a single wick-forming portion located on a single lateral side of the plate, said portion extending in one piece along the entire length of said side or along only a part thereof.

4. The module as claimed in claim 1, wherein the module comprises at least two distinct wick-forming portions located on one and the same lateral side of the plate or on at least two different lateral sides, said portions extending, depending on the case, over the entire length of the respective side or over only a part thereof.

5. The module as claimed in claim 1, wherein the or each wick-forming portion is folded back against the flank of the respective side.

6. The module as claimed in claim 1, wherein the or each side portion includes cutouts forming openings enabling direct contact or partial interlocking of the respective lateral flank of said module with the lateral flank of another abutting module and/or defining several elementary wicks spaced apart and arranged along the respective side.

7. The module as claimed in claim 1, wherein the sheet or piece of non-woven material includes two other side portions in the form of continuous strips extending beyond the edges and along two contiguous lateral sides of the plate, thereby forming an L-shaped protruding portion, the or each wick-forming portion being associated with one of the other two sides of this plate or being cut out from one of these two side portions.

8. The module as claimed in claim 1, wherein the sheet or piece of non-woven material includes, on the part thereof resting on the upper face of the plate, one or more portions or formations of attached, cut and/or deformed material extending inside a cell or cells located opposite, and each constituting a wick for lifting liquid by capillary action.

9. The module as claimed in claim 1, wherein the number, dimensions and arrangement of the wick-forming portion or portions are determined in consideration of the shape and size of the plate, as well as the conditions for implementing said module.

10. The module as claimed in claim 1, wherein the connection between the body in the form of a grid plate with a cellular structure and the sheet or piece of non-woven geotextile material made of synthetic fibers is a material connection, said plate being overmolded on said sheet or piece, the melting temperature of the material forming the plate being advantageously lower than the softening temperature of the material of the fibers of the non-woven material forming the sheet or piece.

11. The module as claimed in claim 1, wherein the sheet or piece includes a non-woven material of synthetic fibers with water capillary and water diffusion properties, the plate being made of polypropylene or ABS, optionally at least partially recycled.

12. The module as claimed in claim 1, wherein at least some of the walls of the cells, common to two cells or otherwise, include slot-shaped cutouts extending from the lower face of the plate to at least halfway up the respective wall.

13. A green or planted flat roof device comprising a flat support which is watertight or covered with a watertight membrane, optionally with an interposed insulating layer,
wherein said device also includes a layer formed by the abutting assembly of modules with a cellular structure in the form of plates as claimed in claim 1, with partial overlapping of the sheets or pieces of non-woven material of the different modules by means of projecting side portions, this continuous layer forming a temporary or non-temporary water retention and controlled-drainage layer, and being covered with a green or planted protective layer.

14. The device as claimed in claim 13, wherein the support and/or the watertight membrane is/are designed in such a way as to promote the formation and preservation of a layer or pools of water under the layer formed by abutting modules.
